(19) United States
(12) Patent Application Publication
(10) Pub. No.: US 2007/0144755 A1
(43) Pub. Date: Jun. 28, 2007

(54) Electric cable with an improved screen

(76) Inventor: Paul Lipkens, Meeuwen-Gruitrode (BE)

Correspondence Address: SOFER & HAROUN LLP., 317 MADISON AVENUE, SUITE 910, NEW YORK, NY, 10017, US

(21) Appl. No.: 11/594,001

(22) Filed: Nov. 7, 2006

(30) Foreign Application Priority Data
Nov. 10, 2005 (FR) 05 53431

(51) Int. Cl. H01B 11/06

(52) U.S. Cl. 174/36

(57) ABSTRACT

The invention relates to an electric cable having at least one central core and a screen surrounding the central core and electrically insulated therefrom. According to the invention, the screen is constituted by a composite tape comprising an insulating substrate and at least one layer of metal deposited on the substrate, one of the two longitudinal edges of the tape overlaps the other edge, and the two edges are welded together by ultrasound until the portions of the metal layers of the two longitudinal edges come into contact, thereby providing electrical continuity. This type of cable can be used in the field of broadband telecommunications.

### RELATED APPLICATION

This application is related to and claims the benefit of priority from French Patent Application No. 05 53431, filed on Nov. 10, 2005, the entirety of which is incorporated herein by reference.

### FIELD OF THE INVENTION

The present invention relates to an electric cable provided with an improved screen and also to a method of manufacturing such a cable.

### BACKGROUND OF THE INVENTION

Electric cables for transporting signals in the form of low currents are particularly sensitive to the electromagnetic interference to which such cables can be subjected. This applies in particular to cables used in the field of telecommunications. Such cables carry analog or digital signals. They are mainly constituted by a central core made up of numerous electrical conductor wires that are insulated from one another, together with a screen constituted by a metal covering surrounding the central core. The signals transported by the conductor wires are protected against interference from electromagnetic waves surrounding the cable by the screen. The electromagnetic performance of the cable depends in particular on the effectiveness of the screen. It must therefore be free from any defects and in particular it must not be pierced, nor must it present any electrical discontinuities that would make it sensitive to electromagnetic disturbances. Defects can arise, for example, as a result of unwanted electrical breakdown in the cable, as a result of corrosion, or as the result of the cable being bent too sharply or too frequently (fatigue effect). Such cables can be used in a corrosive environment (e.g. they might be buried) and their lifetime is relatively long. Thus, solutions have been proposed for improving the characteristics of their screens.

U.S. Pat. No. 3,206,541 describes a cable made up of a set of electrical conductors surrounded by a screen constituted by a composite sheet made up of a layer of aluminum sandwiched between two layers of polyolefin, such as polyethylene. The composite sheet is in the form of a tape that is wrapped around the conductors with the two longitudinal edges of the tape being connected together. The connection between these two edges is provided by the inner layer of polyolefin situated in register with the conductors. It can be seen that the two edges of the aluminum layer do not come into contact. As a result there is electrical discontinuity which is harmful to good operation of the screen.

In another cable structure, e.g. as described in U.S. Pat. No. 5,573,857, the screen is in the form of a tape made up of a composite sheet wound around the set of conductors. The composite sheet comprises layers of different materials, in particular a layer of polyester or polyethylene terephthalate (PET) and a layer of metal (copper or tin). The winding of the tape around the conductors does not ensure that the screen presents good electrical continuity over time. Because of fatigue or of excessive bending being imparted to the cable, it can happen that the edges of the tape are no longer superposed at certain locations.

A variant embodiment of the above type of cable structure with a screen in the form of a wound tape is described in German patent application 199 26 304 A1. The tape of the screen is a composite sheet comprising a sheet of synthetic material, such as PET, sandwiched between two layers of aluminum. The tape is wound around the conductors as in U.S. Pat. No. 5,573,857. That variant thus presents the same drawbacks as mentioned above for that type of structure. In addition, the tape includes nicks or notches, which are harmful for the electrical continuity of the screen.

In order to determine whether a cable is compatible with an electromagnetic environment, tests are proposed in the following standards: EN 50289-1-6 and IEC 61196-1. They describe measuring the value of a characteristic of the screen, known as its transfer impedance ZT, as a function of the frequency of the disturbing electromagnetic wave. The standardized method makes it possible experimentally to obtain results concerning screens that are reproducible and thus comparable. The higher the value of ZT, the lower the effectiveness of the screen. For the screen to be effective, the value of ZT must therefore be below a determined threshold value as a function of the frequency of the disturbing electromagnetic signal. In practice it is difficult if not impossible to obtain values for ZT that are below the threshold values without having recourse to an additional metal sheath, and that increases the cost of manufacturing cables. As a result, cables generally include such an additional sheath surrounding the screen, the sheath often being made of copper and in the form of a braid.

It is also known from U.S. Pat. No. 3,576,939 to use welding under an argon atmosphere in order to connect together the two longitudinal edges of a metal strip forming the screen of an electric cable. Welding in that way is not suitable for metal strips having thickness lying in the range 5 micrometers (μm) to 50 μm.

### OBJECTS AND SUMMARY OF THE INVENTION

The present invention thus provides an electric cable provided with a high performance screen that satisfies electromagnetic compatibility tests without having recourse to an additional metal sheath. Its manufacturing cost is thus less than that of prior art cables.

More precisely, the invention relates to an electric cable comprising at least one central core and a screen surrounding said central core and electrically insulated from the central core, said screen being constituted by a composite tape comprising an insulating substrate and at least one metal layer deposited on the substrate. According to the invention, one of the two longitudinal edges of the tape covers its other edge, and the two edges are welded together by ultrasound until the portions of the metal layers of the two longitudinal edges are in contact so as to provide electrical continuity.

The composite tape preferably comprises said insulating substrate sandwiched between two metal layers.

Advantageously, the insulating substrate is constituted by a plastics material, e.g. polyethylene (PE) or polyester or polyethylene terephthalate (PET), and the metal layer(s) is/are made of a metal selected from aluminum, copper, tin, silver, and gold.

When the central core of the cable is constituted by a plurality of conductors, each forming the same angle of inclination relative to the longitudinal axis of the cable, the angle formed between the longitudinal axis of the tape and the longitudinal axis of the cable is preferably less than or equal to said angle of inclination.

The invention also provides a method of manufacturing a cable as defined above. According to the invention, the method comprises the following steps:
folding the two longitudinal edges of said tape one over the other so as to form an overlap zone; and
welding together the two edges of said tape in the overlap zone by using ultrasound for a length of time that is sufficient to ensure that the portions of the metal layers of the two edges come into contact, thereby ensuring electrical continuity.

### BRIEF DESCRIPTION OF THE DRAWINGS

Other advantages and characteristics of the invention appear from the following description of an embodiment of the invention, given by way of non-limiting example and with reference to the accompanying drawings, in which:

FIGS. 1 and 2 are diagrammatic section views respectively across the longitudinal axis of the cable and parallel thereto, showing a type of cable that is used in the field of telecommunications and that is in accordance with the invention;

FIG. 3 is a diagram showing the operation of the screen being subjected to ultrasound welding in accordance with the invention; and

FIGS. 4 and 5 plot the values of the transfer impedance ZT as a function of the frequency f of the interfering electromagnetic signal for a cable fitted respectively with a prior art screen and with a screen in accordance with the present invention.

### MORE DETAILED DESCRIPTION

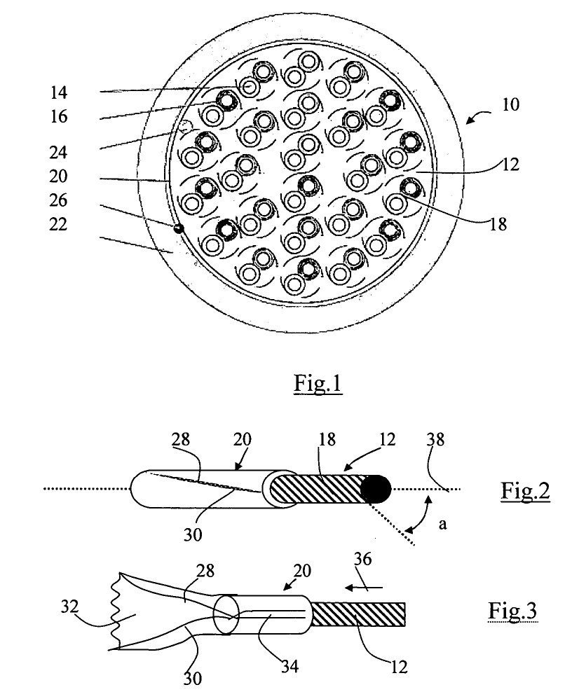

The cable 10 shown in cross-section shown in FIG. 1 is used mainly in the field of telecommunications for conveying a large volume of data. For example, it is usable for high data rate communication of the ADSL type with the Internet. The core 12 of the cable is made up of a plurality of copper conductors 14 of diameter smaller than 1 mm (e.g. 0.4 mm). Each conductor is surrounded by a sheath 16 of insulating plastic, such as polyethylene. The conductors 14 are helically twisted in pairs to form pairs 18, which pairs are likewise helically twisted together to form the core of the cable. By way of example, the core may have 96 pairs of conductors arranged in four bundles of 24 pairs each.

The core 12 is surrounded by a screen 20 constituted by a composite tape of small thickness, which tape comprises a substrate of insulating plastics material having a metal layer deposited on one or both sides of the substrate. The substrate is preferably made of polyethylene (PE) or of polyester (polyethylene terephthalate (PET)) and has a thickness that may lie, for example, in the range 9 μm to 40 μm. The metal forming the metal layer must have very low electrical resistivity and may be constituted, for example, by copper, silver, gold, tin, or preferably aluminum. By way of example, the thickness of the metal layer lies in the range 5 μm to 50 μm. The tape forming the screen 20 is preferably made up of two layers of Al and PET or three layers of Al, PET, and Al (with the plastics substrate being sandwiched between two layers of metal).

The screen 20 is surrounded by an outer sheath 22 of electrically insulating plastics material that withstands corrosion. A conductor wire 24, referred to as the “drain wire”, is connected to ground potential. A cord 26, on being pulled, serves to cut through the outer sheath 22 and thus to separate the sheath 22 from the screen 20.

As shown in FIGS. 2 and 3, and in accordance with the invention, the longitudinal edges 28 and 30 of the tape 32 constituting the screen 20 are folded one over the other so as to form an overlap zone 34. This zone is subjected to ultrasound welding, thereby firstly holding the folded edges 28 and 30 together and secondly for bringing the edges of the aluminum layer(s) into contact. For this purpose, welding speed is determined experimentally as a function of the characteristics of the ultrasound welding machine (ultrasound energy, pressure exerted between the anvil and the ultrasound head, etc.) and as a function of the characteristics of the tape 32 (mainly the thicknesses of the layers of PET and of Al). This provides good electrical continuity for the screen, the edges 28 and 30 of the tape being electrically in contact in the zone 34. The tape as folded over and welded together in this way forms a metal sleeve in which the core 12 of the cable becomes engaged in the direction of arrow 36 as the tape is welded progressively.

In contrast, in the conventional methods of the prior art, the plastics layer (generally of PE or PET) is used either to obtain good adhesion with the sheath that might possibly be located between the core of the cable and the screen, or else to enable the tape to be hot-welded to itself. As a result the electrical continuity of the invention is not obtained.

The tape 32 may be positioned longitudinally around the core 12, with the edges 28 and 30 then being substantially parallel to the longitudinal axis 38 of the cable. The core may also be wrapped in semi-longitudinal manner, as shown in FIG. 2. Under such circumstances, the longitudinal edges 28 and 30 are no longer parallel to the longitudinal axis 38. The helically-twisted pairs 18, and more generally the conductors 14 constituting the core of the cable when such conductors are not grouped together in pairs, form an angle of inclination a relative to the longitudinal axis 38 that varies depending on the cable. According to a characteristic of the invention, the angle formed by the edges 28 and 30 of the tape relative to the longitudinal axis 38 of the cable is less than the angle of inclination α. This can be seen in FIG. 2.

Another, and equivalent, manner of stating this condition consists in comparing the lengths of the cable over which a twisted pair 18 or else the edges 28-30 of the tape turn through 360° about the longitudinal axis 38 of the cable. The length corresponding to the edges of the tape turning through 360° should be shorter than the corresponding length for the twisted pair.

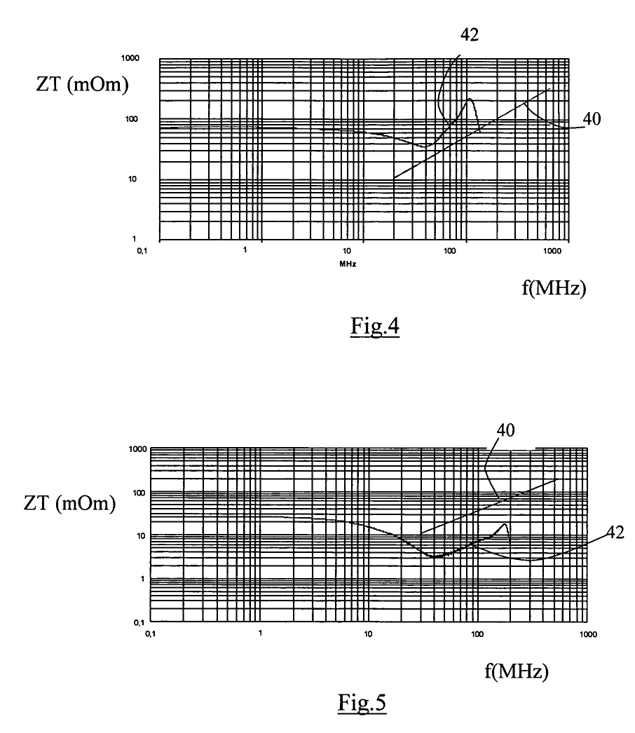

FIGS. 4 and 5 are plots with logarithmic axes showing how the transfer impedance ZT (in milliohms per meter (mΩ/m)) varies as a function of the frequency f (in megahertz (MHz)) of the electromagnetic wave reaching the cable under test, respectively for a prior art cable (FIG. 4) and for a cable in accordance with the invention. The measurements were carried out in compliance with the requirements of the following standards: EN 50289-1-6 and IEC 61196-1. As stated above, the values for ZT provide a good indication of whether the cable is compatible with an electromagnetic environment. It is considered that the screen is effective over the frequency range 30 MHz to 1000 MHz providing the values of ZT are less than the values defined by the curve 40. The curve 42 in FIG. 4 corresponds to a cable with a core made up of 24 twisted pairs of copper conductors each having a diameter of 0.4 mm, a composite Al-PET-Al screen, the aluminum having a thickness of 25 μm and the polyester a thickness of 12 μm, and an outer sheath of copolymer having a thickness of 25 μm. The screen was a tape wound in conventional manner around the core of the cable. It can be seen that the values of ZT are greater than the values defined by the curve 40. The screen of that cable is therefore not sufficiently effective. That is why conventional cables generally have more than one braided metallic sheath around the screen.

Curve 44 in FIG. 5 corresponds to a screen in accordance with the invention, the cable having the same structure as for that of FIG. 4 (a PET substrate with a thickness of 12 μm sandwiched between two Al layers each having a thickness of 25 μm), but the tape was welded longitudinally by ultrasound so as to provide electrical continuity between the longitudinal edges of the tape. It can be seen that the values of ZT are less than the values defined by the curve 40, thereby demonstrating the good effectiveness of the screen against interfering electromagnetic waves. It is therefore possible to omit an additional metal sheath surrounding the screen.

Cables in accordance with the invention are effective from the electromagnetic point of view and they are less expensive to manufacture than conventional cables. The absence of a braided metal sheath around the screen enables manufacturing costs to be reduced.

The person skilled in the art can devise embodiments other than those described and shown without going beyond the ambit of the present invention.

What is claimed is:

1. An electric cable comprising:
at least one central core and a screen surrounding said central core and electrically insulated from the central core, said screen being constituted by a composite tape having an insulating substrate and at least one metal layer deposited on the substrate, wherein one of the two longitudinal edges of the tape covers its other edge, and wherein the two edges are welded together by ultrasound until the portions of the metal layers of the two longitudinal edges are in contact so as to provide electrical continuity.

2. An electric cable according to claim 1, wherein said composite tape comprises said insulating substrate sandwiched between two metal layers.

3. An electric cable according to claim 1, wherein said insulating substrate is constituted by a plastics material.

4. An electric cable according to claim 3, wherein said plastics material is polyethylene or polyester.

5. An electric cable according to claim 1, wherein said metallic layer(s) is constituted using a metal selected from the group consisting of aluminum, copper, tin, silver, and gold.

6. An electric cable according to claim 1, wherein said central core is constituted by a plurality of conductors.

7. An electric cable according to claim 6, in which the longitudinal axes of the conductors all form the same angle of inclination relative to the longitudinal axis of the cable, wherein the angle formed between the longitudinal axis of the tape and the longitudinal axis of the cable is less than or equal to said angle of inclination.

8. A method of manufacturing the cable defined in claim 1, the method comprising the following steps of:
folding the two longitudinal edges of said tape one over the other so as to form an overlap zone; and
welding together the two edges of said tape in the overlap zone by using ultrasound for a length of time that is sufficient to ensure that the portions of the metal layers of the two edges come into contact, thereby ensuring electrical continuity.
